(19) United States
(12) Patent Application Publication
(10) Pub. No.: US 2002/0141010 A1
(43) Pub. Date: Oct. 3, 2002

(54) Coupled data and wavelength reference for optical performance monitoring in fiber optic systems

(76) Inventors: Dave Rodgers, Ottawa (CA); David Macki, Ottawa (CA); Kent Dougall, Kanata (CA)

Correspondence Address: FREEDMAN & ASSOCIATES, 117 CENTREPOINTE DRIVE, SUITE 350, NEPEAN, ONTARIO, K2G 5X3, CA

(21) Appl. No.: 10/096,283

(22) Filed: Mar. 13, 2002

Related U.S. Application Data
(60) Provisional application No. 60/276,835, filed on Mar. 16, 2001.

(51) Int. Cl. G01J 1/04; H04B 10/08; G01J 1/42; G01J 5/08

(52) U.S. Cl. 359/110; 250/227.11

(57) ABSTRACT

With current WDM technology a plurality of individual data channels exist on each fiber. Each of these data channels must be individually monitored in these WDM systems to ensure data signal quality. Monitoring of these signals is accomplished with the use of an optical performance monitor (OPM). An accurate known reference source is required for the OPM to provide reliable monitoring of signal data. The invention couples a reference signal simultaneously with a data signal and provides this combined optical signal to an OPM monitor for the purpose of obtaining high accuracy wavelength data at low cost.

This application claims priority from Provisional Application No. 60/276,835 filed Mar. 16, 2001.

### FIELD OF THE INVENTION

This invention relates to monitoring of optical signal quality within fiber optical transmission systems and more specifically to coupling a reference signal to an optical performance monitor (OPM) for the purpose of obtaining higher accuracy wavelength data from the (OPM).

### BACKGROUND OF THE INVENTION

In order for a network service provider to provide reliable data to their customers, a need exists for the network service provider to monitor the incoming network data in order to guarantee a level of data quality. For fiber optic networks to operate properly between various network service providers strict requirements for signal performance and integrity are provided. Adherence to an ITU (International Telecommunication Union) standard is critical in order for optical networks of various network service providers to efficiently exchange optical data in today's communication networks. Typically performance and integrity is guaranteed through a process of using components within the network that are designed to meet other standards or sub-standards to the ITU standard, however as the marketplace demands more cost effective component solutions, many manufacturers of optical network products reduce their product performance in order to be more cost competitive in the market. Reducing product performance margins may result in components failing to accurately transmit data. As a result, network service providers need to monitor the quality of signals within their networks in order to ensure compliance to ITU standards and in order to assure customers of data transmission signal quality.

In fiber optic networks, data is provided to network service provider in the form of signals modulated within carrier signals at individual wavelength channels transmitted along a fiber optic cable. With current WDM technology a plurality of individual signals within each of several different data channels propagate within a same fiber. Each of these data channels must be individually monitored in these WDM systems to ensure a signal quality. Spectral properties measured for each of the individual wavelength channels are, for example optical power levels vs. wavelength, optical signal to noise ratios, and peak wavelength estimation.

It is therefore an object of this invention to simultaneously couple a reference source with the optical signal and to provide this combined signal to an OPM such that broadband calibration of the OPM is achievable supporting a higher OPM wavelength accuracy.

### SUMMARY OF THE INVENTION

In accordance with the invention there is provided an optical performance monitor for monitoring an optical data signal comprising:

a coupler for receiving the optical data signal and an optical reference signal, for coupling a portion of the optical data signal and a portion of the optical reference signal to form a combined optical signal; and,

a sensor disposed for sensing characteristics of the combined optical signal.

In accordance with the invention there is provided a method of calibrating of an optical performance monitor comprising the steps of:

in a calibration mode

receiving an optical data signal;

receiving an optical reference signal having a known characteristic;

coupling a portion of the optical data signal and a portion of the optical reference signal to provide a combined optical signal;

providing the combined optical signal to a sensor;

detecting with the sensor the characteristic of the reference signal; and, adjusting the optical performance monitor in dependence upon the detected characteristic.

### BRIEF DESCRIPTION OF THE DRAWINGS

The invention will now be described with reference to the drawings in which:

FIG. 1 is an illustration of the placement of an optical performance monitor in a fiber optic network;

FIG. 2 is a block diagram of an optical performance monitor using a tunable filter for selecting wavelength input to an OPM;

FIG. 3 illustrates an example wavelength vs optical power output from an OPM;

FIG. 4 illustrates how calibration of an optical performance monitor using a single local reference and a 1×2 optical switch is achieved;

FIG. 5 illustrates how calibration of an optical performance monitor using a plurality of reference wavelengths and a 1×2 optical switch is achieved;

FIG. 6 illustrates how calibration of an optical performance monitor using a plurality of reference wavelengths combined directly with the optical signal using a fiber coupler is achieved; and,

FIG. 7 illustrates calibration steps for calibrating an optical performance monitor.

### DETAILED DESCRIPTION OF THE INVENTION

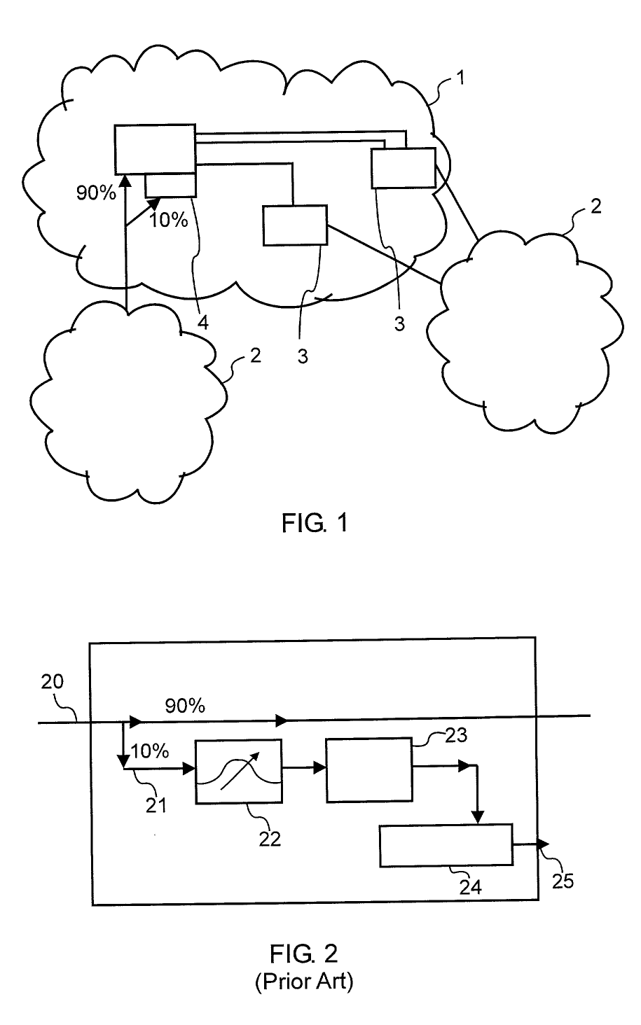

FIG. 1 illustrates placement of an OPM 4 within an optical network environment. Here, nodes 3 within network domain 1 of one service provider communicate with nodes within network domain 2 of other providers. The quality of optical signals received by the provider domain 1 is unknown. Unfortunately, this makes diagnosis of data error sources and network problems difficult. In particular, a provider domain controlling body may erroneously try to diagnose a receiver failure when a problem is actually limited to a transmitter of another network domain. For network reliability and problem diagnosis, the provider adds an OPM 4 to monitor incoming optical data signals to ensure they are within predetermined tolerances.

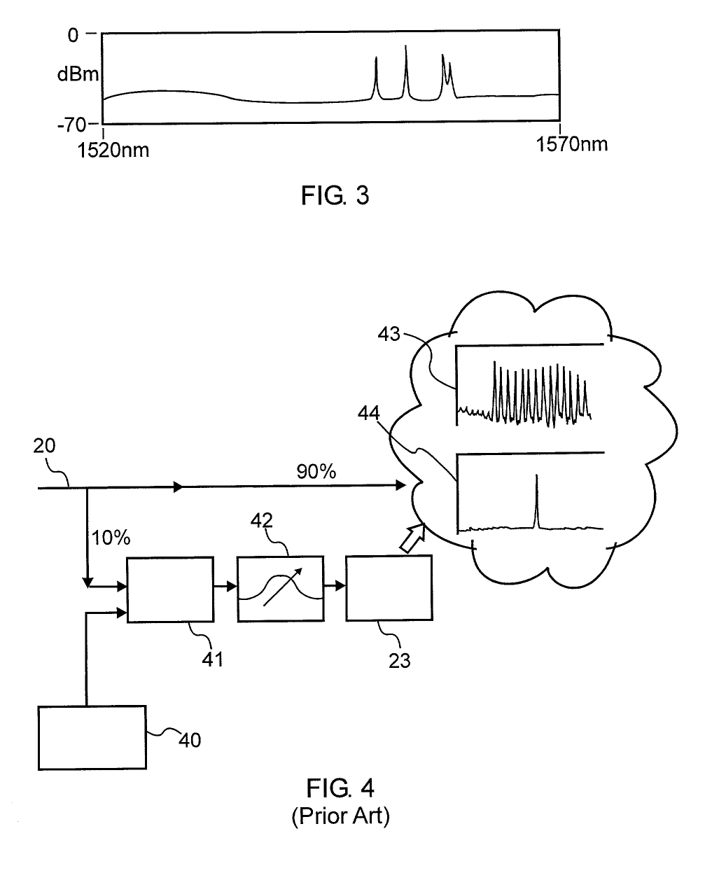

FIG. 2 illustrates a prior art wavelength monitor or Optical Performance Monitor (OPM). OPMs require a low percentage optical tap 21 taken off an incoming optical data signal 20 as their input source for monitoring. A tunable optical filter 22 with a predetermined tunable pass band is varied in wavelength across the wavelength range of interest and the light transmitted through the tunable filter 22 is provided to a photodetector 23. The optical power on the photodetector 23 is processed using digital signal processing circuitry 24, and the information is output using a standard interface 25. The OPM provides simultaneous measurement of all WDM channels along a single optical fibre as is shown in FIG. 3.

Within the OPM it is important to calibrate the exact wavelength of the spectrum to ensure that each of the signals, or peak wavelengths are representative of actual optical signal within the fiber optic cable. The ITU sets a standard to which all optical network component manufacturers must adhere when making components for WDM systems. Without a worldwide standard in place there would be chaos in the optical fibers with manufacturers using different wavelengths and channel widths, rendering optical communication systems inefficient at best. Most scanning techniques used for tunable filters are not inherently accurate enough for the ITU requirements. Placement of dispersive elements may change with thermal exposure, where even a shift of under a micron in internal OPM components can be disastrous. Therefore it is important for most OPMs to have a reference source available such that calibration is possible.

FIG. 4 illustrates a common prior art remedy for calibrating an OPM. The remedy calls for an accurate local calibration reference source 40 at a known wavelength. Light from this local calibration reference source 40 is switched into the tunable filter 42 portion of the OPM periodically via a 1×2 optical switch 41 to ensure wavelength calibration at a single known wavelength. When the 1×2 optical switch is switched into a first position a spectral scan of the data signal 43 is achieved, and then the 1×2 optical switch is switched into a second position a spectral scan of the reference source 44 is obtained. This single wavelength ensures OPM calibration near the wavelength of the local calibration reference source 40. WDM optical signal channels proximate in wavelength to the local calibration reference source 40 will be properly calibrated, however channels falling outside this range will have wavelength accuracy issues since mathematical algorithms are required to extrapolate the wavelength values. Industry requirements require a better calibration for all channels input to the OPM.

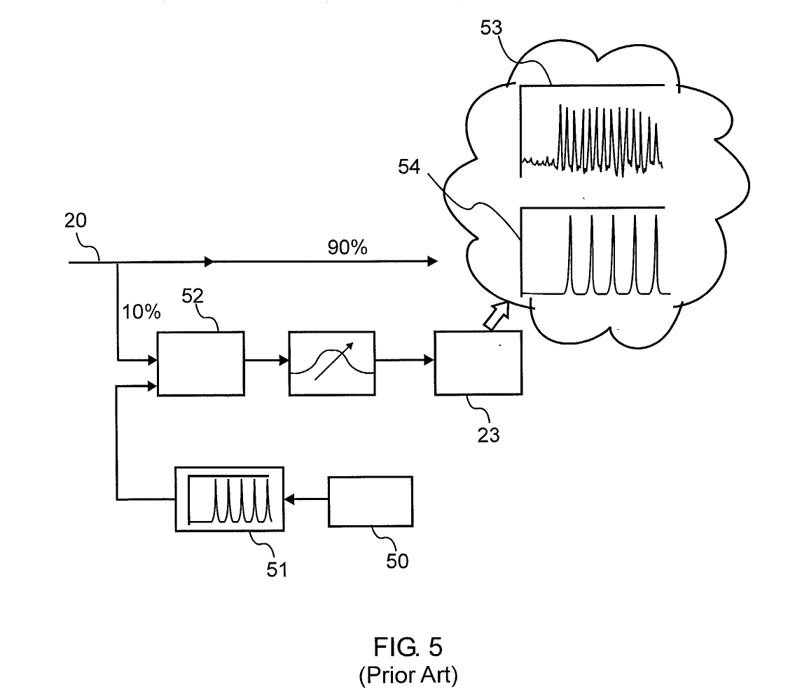

A more accurate apparatus for calibrating the OPM is shown in prior art FIG. 5, where an array of reference sources is distributed throughout the desired spectrum. This array of reference sources is obtained by using a broadband source 50 transmitting through a periodic etalon filter 51. Light from the array of reference sources is switched into the performance monitor periodically using a 1×2 optical switch 52 to ensure wavelength calibration is obtained for a number of wavelength channels represented by the source. This plurality of reference sources from the etalon filter ensures much better OPM calibration accuracy for a plurality of wavelengths. Unfortunately since either the reference source 54 or the optical signal 53 is switched in to the OPM there is still potential loss of calibration between the reference source spectral scan 54 and the optical data spectral scan 53. Although this technique affords much better calibration of the OPM than with using a single wavelength reference source 40, it is still not ideal. The calibration will not be as accurate as if the reference source and the optical signal were provided to the OPM simultaneously such that simultaneous measurements of both spectra are possible.

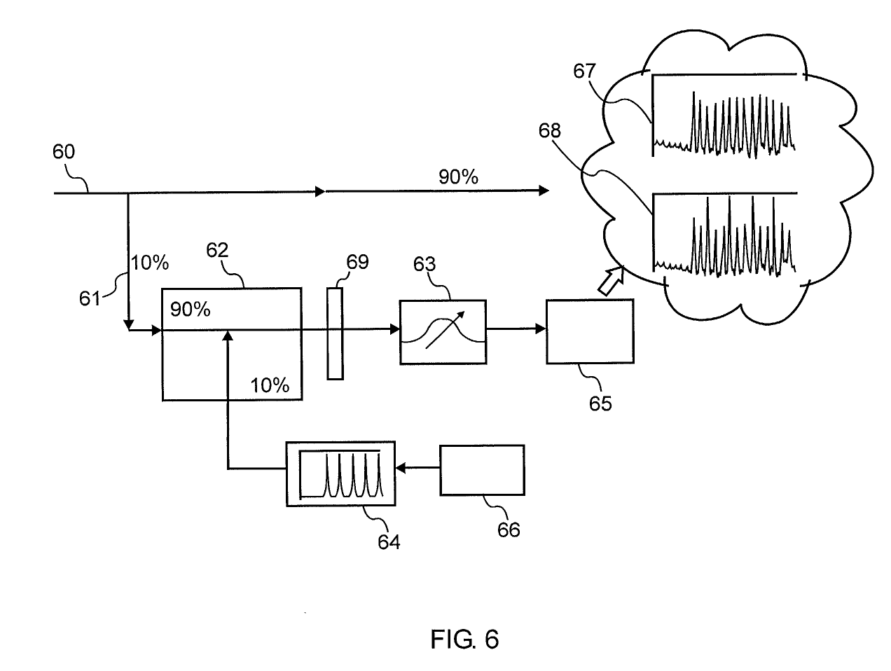

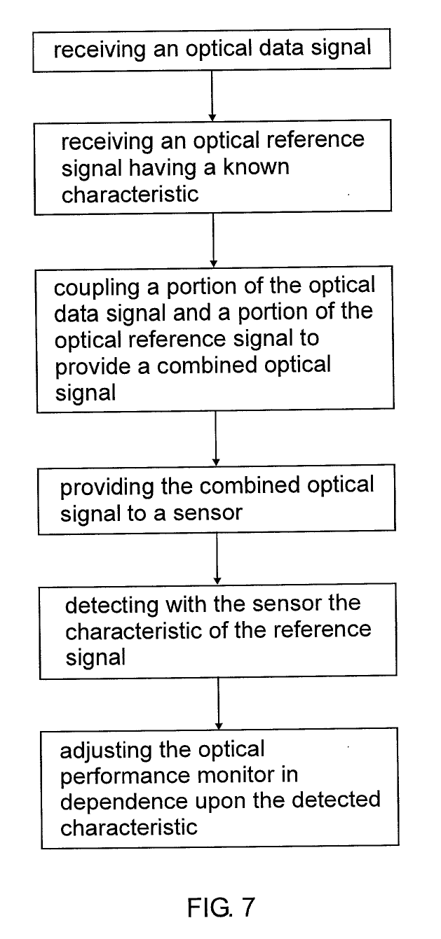

FIG. 6 illustrates the primary embodiment of the invention, highlighting an improvement in OPM calibration. A portion of an incoming WDM data signal 60 is tapped off using a 10%/90% optical power coupler. Ten percent of the data signal 61 is provided to a second 10%/90% optical power coupler 62 into the ninety percent port of said coupler 62. Steps outlining a calibration process for the OPM are outlined in FIG. 7.

A broadband light source 66 shines light through an etalon filter 64. The etalon filter 64 forms an optical resonance cavity where optical peaks and valleys are obtained on the output in dependence upon the width of the optical resonance cavity 64 and the wavelength range of the broadband source 66. The peaks of the etalon filter 64 are aligned to correspond to the valleys in between peak wavelengths of the optical data signal 60. This resulting peak and valley output is referred to as the reference comb. This reference comb is input on the 10% port of the second 10%/90% optical power coupler 62.

Together the combined signals, reference and data are emitted from the output port of the second 10%/90% optical power coupler. These combined signals pass through a broadband optical filter 69, and further to an optical tunable filter 63 and the output signal of this tunable filter is provided to a photodetector 65. In operation the optical tunable filter is swept across the desired wavelength band and the photodetector generates a photocurrent in dependence upon the optical power received. Advantageously, the broadband optical filter 69 is provided for filtering the combined optical signal prior to measurement. In this manner the filter 69 passband is chosen to eliminate extraneous optical signals present outside the filter FSR, since these signals could impact measurements by the performance monitor.

The reference source 66 has two modes of operation, in that it can either be enabled or disabled. If disabled, no light passes through the etalon filter, resulting in no reference comb provided to the photodetector via the tunable filter and an optical data signal spectral scan 67 is generated by the OPM. If enabled, light passes through the etalon filter forming the reference comb and in combination with the data signal passes to the photodetector via the tunable filter. The resulting spectral scan 68 generated by the OPM is an overlay of the reference comb and the optical data signal.

Ideally the spectral location of the reference comb peaks is in the valley between adjacent optical data signal wavelength peaks, thereby enabling recalibration of the optical filter pass band wavelength position and tunable filter tuning voltage. Alternatively, if the reference peaks are aligned with the data peaks then the optical power levels of the reference comb peaks are preferably higher than those of the optical data signal. This results in the reference comb peaks to be distinguishable over the optical data signal.

Advantageously, simultaneously coupling of the reference source with the optical signal and providing this combined signal to an OPM affords optimum wavelength accuracy of the OPM since an absolute controllable optical reference is simultaneously provided in the combined optical signal. The primary embodiment also affords a lower assembly cost since no 1×2 optical switch is required as compared with the prior art scenario shown in FIG. 5. Disadvantageously, the second optical coupler 62 used to combine the reference and data signals adds loss to the tapped data signal. The optical power of the broadband source is variable to ensure that the peaks of the reference source are distinguishable over the data signal when a combined spectral scan is performed. With the use of a 10%/90% coupler only a 1 dB loss in the second optical coupler 62 is incurred.

Advantageously, combining of the reference optical signal and the data signal into a combined optical signal allows for simultaneous calibration of the wavelength monitor while a performing data signal scans. The reference optical signal source is modulated at a known modulation frequency, preferably a low frequency such that there is minimal interference between the modulation frequency and the data signal frequency. A lock in computer algorithm or electrical circuit is tuned to operate at the modulation frequency, such that only reference optical signal components at this frequency will be available to the control circuit, allowing for calibrating while simultaneously allowing for monitoring of the data signal at frequencies other than the modulation frequency. This resulting in the highest advantage afforded by the invention because of allowing for simultaneous reference monitoring and optical data signal monitoring.

In an alternative embodiment the data signal tap and the second optical coupler are chosen to have a different power splitting ratios other than 10%/90%. Ideally the power splitting values of both couplers are chosen such that a minimum optical power is tapped off the original data signal 60, yet enough optical power impacts the photodetector such that a high enough signal to noise ratio is obtained in the spectral scan. The optical power level of the broadband source is varied to ensure that its peaks are distinguishable over the data signal.

Alternatively if the polarization of the input data signal 60 is known, then optionally both couplers are replaced with a polarization dependent coupler. Polarization dependent coupler allow for very high coupling of both the data signal and the reference signal onto the same fiber.

In yet another alternative embodiment the reference comb is not limited to a broadband source transmitted through an etalon filter. Any known reference spectrum is provided as the reference source, such as a Multiple-stripe array grating Integrated cavity (MAGIC) laser, or coupled Fabry-Perot laser, or externally gain coupled SLLED.

In yet another alternative embodiment wavelength tuning is obviated by using a wavelength dispersive element such as a diffraction grating or a prism; however if a dispersive element is chosen instead of the tunable filter then the parts cost of the device increases since a photodiode array is used in combination with the wavelength dispersive element. An option utilizing a single photodetector and a wavelength dispersive element incorporates a scanning grating arrangement. However moving parts are not desirable within optical network devices and as such moving parts are limited in their practice use.

Numerous other embodiments may be envisaged without departing from the spirit or scope of the invention.

What is claimed is:

1. An optical performance monitor for monitoring an optical data signal comprising:
a coupler for receiving the optical data signal and an optical reference signal, for coupling;
a portion of the optical data signal and a portion of the optical reference signal to form a combined optical signal; and, a sensor disposed for sensing characteristics of the combined optical signal.

2. An optical performance monitor according to claim 1 comprising an optical reference source for providing the optical reference signal.

3. An optical performance monitor according to claim 1 comprising a wavelength selective element disposed between the combined optical signal and the sensor for controllably filtering signal portions other than portions of the combined optical signal about a wavelength of interest.

4. An optical performance monitor according to claim 3 wherein the wavelength selective element is tunable for filtering other than the different portions of the combined optical signal.

5. An optical performance monitor according to claim 4 wherein the wavelength selective element is a wavelength dispersive element.

6. An optical performance monitor according to claim 5, wherein the wavelength selective element is a diffraction grating.

7. An optical performance monitor according to claim 5 wherein the wavelength selective element is a prism.

8. An optical performance monitor according to claim 5 comprising another sensor, wherein:
the sensor is disposed for sensing characteristics of the combined optical signal about a known wavelength, and
the other sensor is disposed for sensing characteristics of the combined optical signal about a known other wavelength.

9. An optical performance monitor according to claim 2 wherein the optical reference source comprises:
a broadband laser source; and,
an etalon filter, wherein in use light provided from the broadband laser source propagates through the etalon filter.

10. An optical performance monitor according to claim 9 wherein the etalon filter comprises a tuneable optical resonant cavity.

11. An optical performance monitor according to claim 10 wherein the spectral peaks emitted from the etalon cavity are spectrally located in between optical data signal peaks as part of the combined optical data signal.

12. An optical performance monitor according to claim 1 wherein the coupler is a polarization dependent coupler.

13. An optical performance monitor according to claim 1 comprising an amplifier circuit for distinguishing the portion of the optical reference source from the combined optical signal at a frequency of modulation of the optical reference source.

14. An optical performance monitor according to claim 13 wherein the amplifier circuit is a lock in amplifier tuned to operate at the frequency of operation of the optical reference source.

15. An optical performance monitor according to claim 1 comprising a broadband optical filter having a predetermined filter passband disposed within an optical path of the combined optical signal for filtering the combined optical signal to provide a passband spectral portion thereof.

16. A method of calibrating of an optical performance monitor comprising the steps of:
in a calibration mode;
receiving an optical data signal;
receiving an optical reference signal having a known characteristic;
coupling a portion of the optical data signal and a portion of the optical reference signal to provide a combined optical signal;
providing the combined optical signal to a sensor; detecting with the sensor the characteristic of the reference signal; and,
adjusting the optical performance monitor in dependence upon the detected characteristic.

17. A method according to claim 16 wherein in a monitoring mode the following steps are performed:
receiving an optical data signal;
providing a portion of the optical data signal to a sensor; and
detecting with the sensor a characteristic of the optical data signal.

18. A method of calibrating of an optical performance monitor according to claim 17 comprising the step of providing a reference signal coupled with a portion of the optical data signal in the monitoring mode.

19. A method of calibrating of an optical performance monitor according to claim 18 comprising the step of decreasing the optical power of the optical reference signal in order to obtain a measure of the characteristic of the optical data signal in the monitoring mode.

20. A method of calibrating of an optical performance monitor according to claim 16 comprising the step of distinguishing the optical reference signal from the optical data signal in the calibration mode.

21. A method of calibrating of an optical performance monitor according to claim 20 wherein the spectral peaks emitted from the optical reference source are between spectral peaks of the optical data signal.

22. A method of calibrating of an optical performance monitor according to claim 20 comprising the step of varying the optical power of the optical reference signal to increase a proportion of the reference signal within the combined optical signal in the calibration mode.

23. A method of calibrating of an optical performance monitor according to claim 16 comprising the step of providing a wavelength selective element disposed between the combined optical signal and the sensor for controllably filtering signal portions other than portions of the combined optical signal about a wavelength of interest.

24. A method of calibrating of an optical performance monitor according to claim 23 wherein the wavelength selective element is tuneable for filtering other than different portions of the combined optical signal.

25. A method of calibrating of an optical performance monitor according to claim 24 wherein the wavelength selective element a wavelength dispersive element.

26. A method of calibrating of an optical performance monitor according to claim 25 wherein:
the sensor is disposed for sensing the characteristics of the combined optical signal about a known wavelength, and
the other sensor is disposed for sensing the characteristics of the combined optical signal about a known other wavelength.

27. A method of calibrating of an optical performance monitor according to claim 16 comprising the steps of:
modulating the optical reference signal at a known frequency; and,
wherein the step of detecting the characteristic of the reference signal is performed at the known frequency.

28. A method of calibrating of an optical performance monitor according to claim 16, wherein spectral peaks emitted from the optical reference source are between spectral peaks of the optical data signal as part of the combined optical signal.

29. A method of calibrating of an optical performance monitor according to claim 16, comprising the step of providing a broadband optical filter having a predetermined filter passband for transmitting a passband spectral portion of the combined optical data signal to the sensor.
